(19) United States
(12) Patent Application Publication
(10) Pub. No.: US 2005/0260885 A1
(43) Pub. Date: Nov. 24, 2005

(54) Flexible board electrical connector

(75) Inventor: Yao Pang Lu, Tu-Chen (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/028,110

(22) Filed: Dec. 31, 2004

(30) Foreign Application Priority Data
May 24, 2004 (TW) 93114592

(51) Int. Cl. H01R 12/24

(52) U.S. Cl. 439/495

(57) ABSTRACT

An electrical connector (1) for a flexible circuit includes an insulative housing (2) defining a circuit-insertion slot (201) in one face thereof and a pair of actuator holes (211) in opposite sides thereof, a number of terminals (3) mounted to the housing and spaced along the slot for engaging conductors spaced along the flexible circuit, and an actuator (4) having a shaft (41) pivotally located in the actuator holes for movement between an open position allowing insertion of the flexible circuit into the slot and a closed position biasing the circuit and its conductors against the contact portions of the terminals, and a pair of positioning members (5) formed on the shaft to prevent the shaft from falling out of the actuator holes.

### BACKGROUND OF THE INVENTION

1. Field of the Invention

The present invention relates to electrical connectors and more particularly, to an electrical connector for flexible flat cables or flexible printed circuit boards.

2. Description of Related Art

Typical electrical connectors for flexible flat cables (FFC) or flexible printed circuit boards (FPC) comprise an insulating or dielectric housing having an insertion aperture and a plurality of terminals disposed within the housing in side-by-side relationship with a predetermined pitch. The terminals have contact portions which extend into the insertion aperture in such a way that they can contact conductive areas of the FFC or FPC. The housing also often comprises a pivoting actuator (pressure clamp) which can be moved from an “open” state in which the FFC or FPC can be inserted into the insertion aperture, into a “closed” state in which the FFC or FPC and the connections thereof are pressed against the contact region of the terminals. Such conventional flexible board connectors are disclosed in U.S. Pat. Nos. 5,639,260, 5,580,272 and 6,206,723 B1.

However, the conventional connector mentioned above, the actuator is coupled to the housing simply by engagement between both ends of the actuator and the housing. With this structure, the actuator is often released or disengaged from the housing. If the FPC or FFC is subjected to pull force while it is brought into contact with the terminals, the shaft portion of the actuator is also pulled due to friction between the FPC or FFC and the shaft portion. In this event, the actuator will undesiredly be released from the housing.

Hence, a flexible board electrical connector with a reliable actuator is desired to overcome the disadvantages of the prior art.

### SUMMARY OF THE INVENTION

An object of the present invention is to provide an electrical connector which is capable of preventing disengagement of an actuator with high reliability.

Another object of the present invention is to provide a flexible board electrical connector which is capable of suppressing the risk of disengagement of an actuator even if a flexible flat cable or flexible printed circuit board connected to the connector is subjected to pull force.

In order to achieve the above object, a flexible board electrical connector according to the present invention for a flexible circuit includes an insulative housing defining a circuit-insertion slot in one face thereof and a pair of actuator holes in opposite sides thereof, a number of terminals mounted to the housing and spaced along the slot for engaging conductors spaced along the flexible circuit, an actuator having a shaft pivotally located in the actuator holes for movement between an open position allowing insertion of the flexible circuit into the slot and a closed position biasing the circuit and its conductors against the contact portions of the terminals, and a pair of positioning members formed on the shaft to prevent the shaft from falling out of the actuator holes.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is an exploded view of a flexible board electrical connector according to the present invention.

FIG. 2 is an assembled view the electrical connector of FIG. 1, with an actuator in an open position.

FIG. 3 is an assembled view of the electrical connector of FIG. 1, wherein the actuator is in a closed position.

### DETAILED DESCRIPTION OF THE PREFERRED EMBODIMENTS

The present invention will be discussed hereafter in detail in terms of the preferred embodiment of the present invention with reference to the accompanying drawings. In the following description, numerous specific details are set for the in order to provided a thorough understanding of the present invention. It will be obvious, however, to those skilled in the art that the present invention may be practiced without these specific detail. In other instances, well-known structures are not shown in detail in order to avoid unnecessary obscurity of the present invention

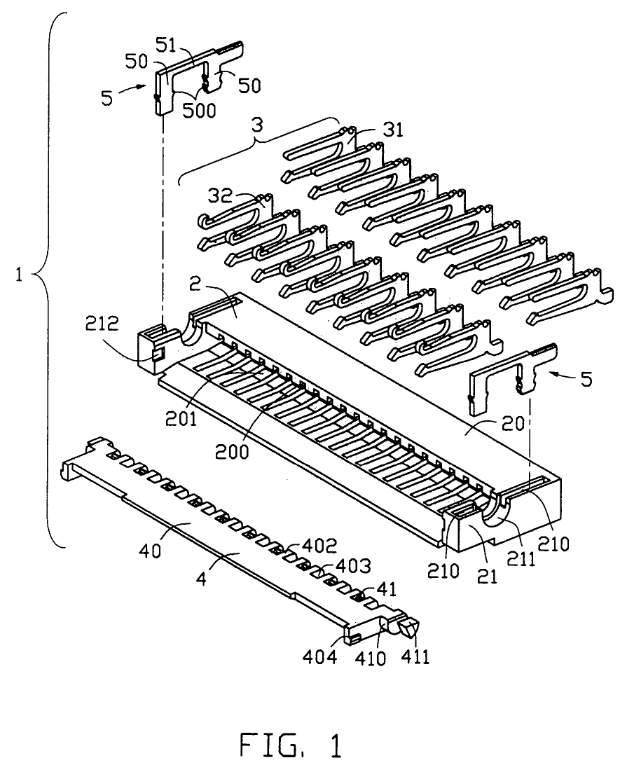

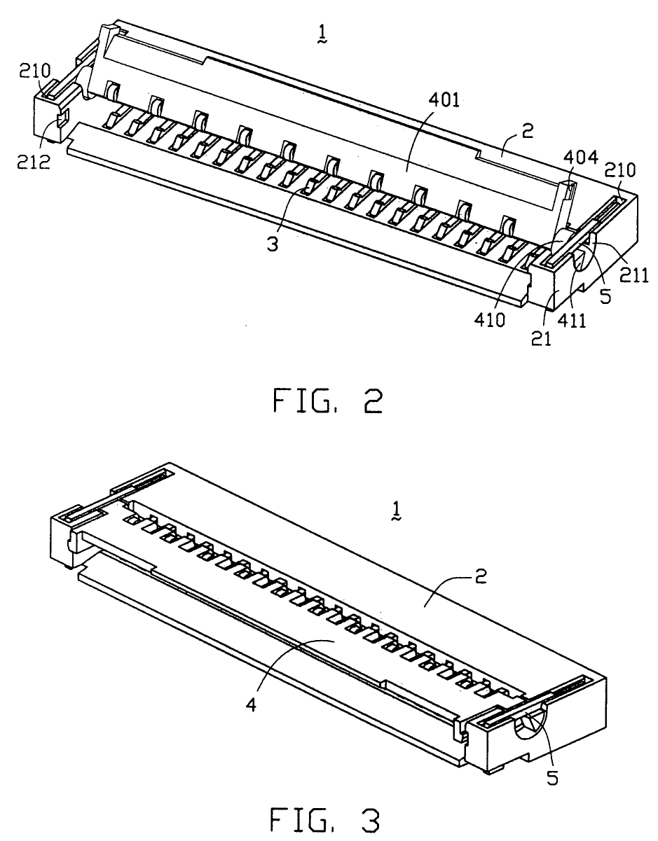

Referring to FIGS. 1-3, a flexible board electrical connector 1 in accordance with the present invention is adapted for connecting a flexible flat cable (FFC, not shown) or flexible printed circuit board (FPC, not shown) to a motherboard (not shown). The electrical connector includes an elongate insulative housing 2, a plurality of conductive terminals 3, an actuator 4 pivotally mounted on the housing 2 for movement between an open position (shown in FIG. 2) and a closed position (shown in FIG. 3), and a pair of positioning members 5 for securely holding the actuator 4 in the housing 2. In the open position, the actuator 4 allows insertion of the FFC or FPC into the electrical connector 1. In the closed position, the actuator biases the FFC or FPC against the terminals 3 mounted in the housing 2, as described hereinafter. Although the FFC or FPC is not shown in the drawings, the FFC or FPC typically will have generally parallel conductor strips running the length thereof and to a distal end of the circuit which is inserted into the connector.

As best shown in FIG. 1, the housing 2 includes an elongate base 20 and a pair of side walls 21 integrally formed on opposite sides of the base 20. The base 20 defines an insertion slot 210 on a front side thereof for receiving the FFC or FPC, and a plurality of terminal channels 200 in a bottom side thereof. The terminal channels 200 are spaced apart with a predetermined interval therebetween for receiving the conductive terminals 3. Each side wall 21 defines a recess 210 for receiving the positioning member 5, and an actuator hole 211 running through thereof and separating the recess 210 into two parts. The side walls 21 respectively define a notch 212 facing toward each other for engaging with the actuator 4, as will be fully discussed.

Generally, the electrical connector 1 has two types of conductive terminals 3 mounted on the housing 1 at spaced intervals along the insertion slot 210. Specifically shown in FIG. 1, one type of conductive terminal which will be called a retention terminal, generally designated 31, and a second type of conductive terminal which will be called a non-retentive terminal, generally designated 32. Retention terminals 31 and non-retentive terminals 32 alternate in spaced, generally parallel relationship along the length of insertion slot 15.

Referring to FIGS. 2 and 3 in conjunction with FIG. 1, the actuator 4 is pivotally mounted on the housing 1 for pivotal movement between its open position (FIG. 2) and its closed position (FIG. 3). The actuator 4 comprises an elongate pressure section 40 and a driving shaft 41 positioned in a rear portion of the pressure section 40. The elongate pressure section 40 includes a pressure surface 401 for pressing against an upper surface of the insertion FFC or FPC. A plurality of partition walls 402 are periodically spaced along the rear portion of the elongate pressure section 40, thereby forming a plurality of passages 403 between adjacent two partition walls 402. The pressure section 40 further has a pair of positioning bars 404 on opposite sides thereof for engaging with corresponding notches 212 of the housing 2 when the electrical connector 1 is in its closed state. The driving shaft 41 includes a pair of pivot portions 410 projecting from opposite ends of the pressure section 40, and a pair of cam portions 411 respectively extending outwardly from the pivot portions 410 and vertically offset from the pivot portions 410. Each cam portion 411 is integrally formed with the pivot portion 410 and has a section defined by a semicircle connected by two straight lines. However, the shape of the cam portion 411 may be modified in various manners.

The positioning members 5 are stamped from a metal sheet and are substantially F-shaped. Each positioning member 5 comprises first and second latching legs 50 and a connecting leg 51 connecting the first and second latching legs 50. Each latching leg 50 forms a plurality of barbs 200 on opposite sides thereof for latchably engaging with the recesses 210 of the housing 2.

With reference to FIGS. 1-3, in assembly, the conductive terminals 3 are respectively inserted into corresponding terminal channels 200 of the housing 2 with contacting portions (not labeled) exposed to the insertion slot. The actuator 4 is movably mounted on the housing 2. The pivot portions 410 and the cam portions 411 of the driving shafts 41 are received in the actuator holes 211 of the housing 2. The positioning members 5 are mounted on the housing 2 thereafter. The barbs 500 of the latching legs 50 of the positioning member 5 are interferentially fitted in the recess 210 of the housing 2, and the connecting legs 51 respectively abut against the cam portions 411 of the pressure section 40. It should be noted that the latching legs 50 may selectively extend through the recess 210 and extend beyond a bottom surface of the housing 2 for being soldered to a motherboard (not shown), thereby capturing the electrical connector to the motherboard.

In operation of the electrical connector 1 herein, the actuator 4 is pivoted upwardly to its open position as shown in FIG. 2. The FFC or FPC then is inserted into the insertion slot 201 of the electrical connector 1, until a tip or front edge of the FFC or FPC abuts against the contact portions of the terminals 3. As best shown in FIG. 3, the actuator 4 then is pulled forward to its closed position for pressing against the FFC or FPC. During this operation, the pivot portions 410 of the driving shaft 41 move along the actuator holes 211 of the housing 2 until the positioning bars 404 are held in the notches 212 of the housing 2 by an interference fit respectively. Thus, the actuator 4 is secured in a closed position and the pressure section 40 biases against the upper surface of the FFC or FPC, thereby establishing the electrical connection between the terminals 3 and the FPC or FFC. It should be noted that, during the pivot movement of the actuator 4, the connecting legs 51 of the positioning members 5 abut against the cam portions 411 of the driving shaft 41 to ensure the pivot portions 410 in the actuator holes 211 respectively. Therefore, a reliable electrical transmission path between FFC or FPC and the terminal 3 is established.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An electrical connector adapted for connecting a flexible circuit to a motherboard, comprising:
an insulative housing defining a circuit-insertion slot in one face thereof and a pair of actuator holes in opposite sides thereof;
a plurality of terminals mounted to the housing and spaced along the slot, the terminals having contact portions for engaging conductors spaced along the flexible circuit;
an actuator movably mounted on the housing for movement between an open position allowing insertion of the flexible circuit into the slot and a closed position biasing the circuit and its conductors against the contact portions of the terminals, the actuator including a pressure section for pressing against the flexible circuit and a shaft rotatably and slidably located in the actuator holes for providing pivot movement of the actuator between the open position and the closed position;
a pair of positioning members formed on the shaft and the housing to prevent the shaft from falling out of the actuator holes during the movement of the actuator.

2. The electrical connector as claimed in claim 1, wherein the shaft comprises a pair of pivot portions and a pair of cam portions projecting outwardly and vertically offset from the pivot portions.

3. The electrical connector as claimed in claim 2, wherein the cam portion has a section defined by a semicircle connected by two straight lines.

4. The electrical connector as claimed in claim 2, wherein each positioning member has a connecting leg holding the cam portion in the actuator hole.

5. The electrical connector as claimed in claim 2, wherein the housing defines a pair of recesses, and wherein each positioning member includes a latching leg retained in a corresponding recess.

6. The electrical connector as claimed in claim 5, wherein the latching leg extends through the recess for being mounted to the motherboard.

7. The electrical connector as claimed in claim 1, wherein the housing defines a pair of notches in opposite sides thereof, and wherein the pressure section of the actuator has a pair of positioning bars engaging with corresponding notches in the closed position.

8. A flexible board electrical connector for connecting a flexible circuit to a motherboard, comprising:
a plurality of first and second terminals each having contacting portion for contacting to the flexible circuit;
an insulative housing holding said first and said second terminals at a predetermined pitch, said housing comprising an actuator hole and a positioning recess;
an actuator for bringing said flexible circuit into press contact with said first and said second terminals, said actuator comprising a cam portion rotatably engaging with the actuator hole of the housing;
a positioning member retained in said positioning recess and having a leg positioned on the cam portion for preventing disengagement of the cam portion and the actuator holes.

9. The flexible board electrical connector as claimed in claim 8, wherein the positioning member has a latching leg extend through the recess for mounting on the motherboard.

10. The flexible board electrical connector as claimed in claim 8, wherein the positioning member is substantially F-shaped.

11. The flexible board electrical connector as claimed in claim 8, wherein the actuator includes a pressure section for pressing against the flexible board.

12. The flexible board electrical connector as claimed in claim 11, wherein the housing has a side wall defining a notch therein, and wherein the pressure section has a positioning bar in one side thereof engaging with the notch while the pressure section bias against the fully insertion flexible board.

13. A flexible board electrical connector for connecting a flexible circuit to a motherboard, comprising:
an insulative housing defining a receiving space for receiving said flexible circuit, and a pair of actuator holes at two opposite lengthwise ends, each of said hole defining an opening;
a plurality of terminals each having contacting portion for contacting to the flexible circuit;
a rotatable actuator for bringing said flexible circuit into press contact with said first and said second terminals, said actuator comprising a pair of pivotal portions each installed into the corresponding actuator hole via the opening, and rotatably engaging with the actuator hole of the housing;
a positioning member attached to the housing after the actuator is assembled to the housing and defining means for blocking said opening of the actuator hole so as to prevent the pivotal portion of the actuator from being withdrawn from the corresponding actuator hole.

14. The connector as claimed in claim 13, wherein said opening faces upwardly so as to allow the corresponding pivotal portion of the actuator to be downwardly assembled into the corresponding actuator hole from an exterior.

15. The connector as claimed in claim 13, wherein said housing defines a recess exposed to an exterior, and the positioning member is assembled into the recess.

16. The connector as claimed in claim 15, wherein said recess faces upwardly so as to allow the corresponding positioning member is downwardly assembled into the recess.
